(19) United States
(12) Patent Application Publication
(10) Pub. No.: US 2017/0024236 A1
(43) Pub. Date: Jan. 26, 2017

(54) INFORMATION PROCESSING SYSTEM, TERMINAL APPARATUS, AND NON-TRANSITORY COMPUTER READABLE MEDIUM

(71) Applicant: FUJI XEROX CO., LTD., Tokyo (JP)

(72) Inventors: Yasuyuki FURUKAWA, Kanagawa (JP); Toshiyuki KOMODA, Kanagawa (JP)

(73) Assignee: FUJI XEROX CO., LTD., Tokyo (JP)

(21) Appl. No.: 14/996,998

(22) Filed: Jan. 15, 2016

(30) Foreign Application Priority Data
Jul. 23, 2015 (JP) 2015-145667

(51) Int. Cl. G06F 9/455

(52) U.S. Cl. CPC G06F 9/45558; G06F 2009/45595; G06F 2009/4557

(57) ABSTRACT

An information processing system includes a virtual machine, a first terminal apparatus, and a second terminal apparatus different from the first terminal apparatus. In the case where the virtual machine is connected to the first terminal apparatus, when the first terminal apparatus detects an external apparatus, the virtual machine sets a setting indicating that the virtual machine is to use the external apparatus. In the case where the virtual machine is connected to the second terminal apparatus, when the second terminal apparatus detects the external apparatus, the virtual machine uses the external apparatus by using the setting.

### CROSS-REFERENCE TO RELATED APPLICATIONS

This application is based on and claims priority under 35 USC 119 from Japanese Patent Application No. 2015-145667 filed Jul. 23, 2015.

### BACKGROUND

### Technical Field

The present invention relates to an information processing system, a terminal apparatus, and a non-transitory computer readable medium.

### SUMMARY

According to an aspect of the invention, there is provided an information processing system including a virtual machine, a first terminal apparatus, and a second terminal apparatus different from the first terminal apparatus. In the case where the virtual machine is connected to the first terminal apparatus, when the first terminal apparatus detects an external apparatus, the virtual machine sets a setting indicating that the virtual machine is to use the external apparatus. In the case where the virtual machine is connected to the second terminal apparatus, when the second terminal apparatus detects the external apparatus, the virtual machine uses the external apparatus by using the setting.

### BRIEF DESCRIPTION OF THE DRAWINGS

Exemplary embodiment of the present invention will be described in detail based on the following figures, wherein:

FIG. 1 is a diagram illustrating apparatuses constituting an information processing system according to an exemplary embodiment of the present invention;

FIG. 2 is a diagram illustrating the hardware configuration of a terminal apparatus;

FIG. 3 is a diagram illustrating an exemplary connection destination table;

FIG. 4 is a functional block diagram of the terminal apparatus;

FIG. 5 is a diagram illustrating the hardware configuration of a server apparatus;

FIG. 6 is a functional block diagram of the server apparatus;

FIG. 7 is a sequence chart for describing exemplary operations according to the exemplary embodiment;

FIG. 8 is a diagram illustrating an exemplary screen displayed on a touch panel;

FIG. 9 is a flowchart illustrating a process flow performed by the terminal apparatus;

FIG. 10 is a sequence chart for describing exemplary operations according to the exemplary embodiment;

FIG. 11 is a flowchart illustrating a process flow performed by a virtual machine;

FIG. 12 is a flowchart illustrating a process flow performed by the virtual machine;

FIG. 13 is a diagram illustrating an exemplary screen displayed on the touch panel; and

FIG. 14 is a sequence chart for describing exemplary operations according to the exemplary embodiment.

### DETAILED DESCRIPTION

### Exemplary Embodiment

### Overall Configuration

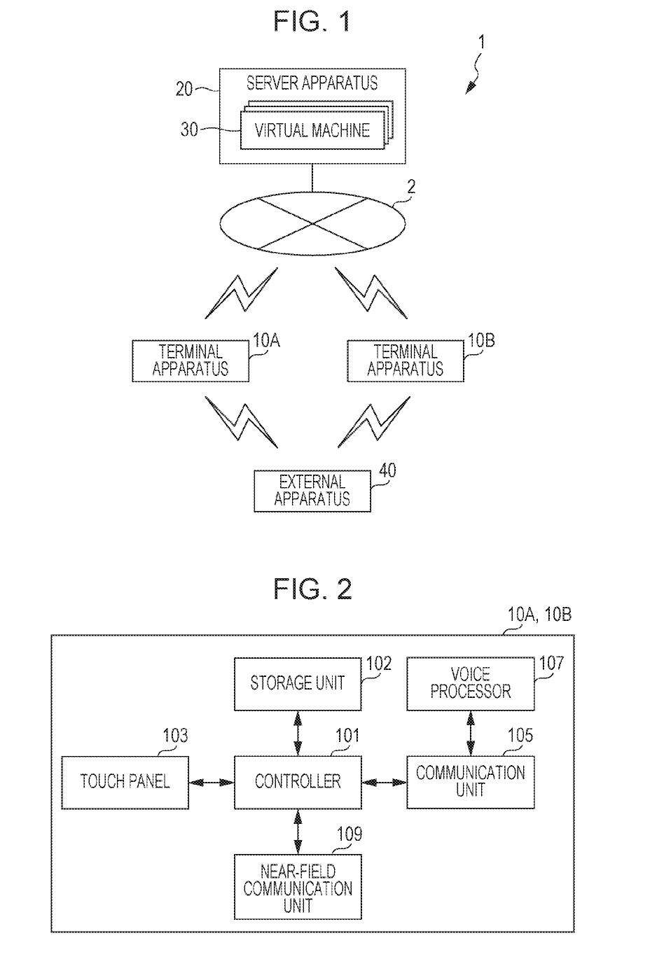

FIG. 1 is a diagram illustrating apparatuses in an information processing system 1 according to an exemplary embodiment of the present invention. A communication line 2 which is a communication network in which data communication is performed is connected to multiple computer apparatuses performing data communication. The communication line 2 encompasses wired and wireless networks.

Terminal apparatuses 10A and 10B each are an apparatus performing data communication, and are a smartphone or a tablet terminal in the present exemplary embodiment. Each of the terminal apparatuses 10A and 10B which is connected to the communication line 2 via an access point in a wireless local area network (LAN) included in the communication line 2 performs data communication via the communication line 2. Each of the terminal apparatuses 10A and 10B functions as a client terminal serving as a thin client.

A server apparatus 20 functions as a server apparatus for thin clients. The server apparatus 20 invokes a virtual machine 30 for each user authenticated by the server apparatus 20. The virtual machine 30 is connected to the terminal apparatuses 10A and 10B. The virtual machine 30 transmits information about a graphical user interface (GUI) screen for operating the virtual machine 30, to the terminal apparatuses 10A and 10B. When input of information or an operation is performed on the GUI screen displayed by the terminal apparatus 10A or 10B on the basis of the received information, the virtual machine 30 performs various types of information processing in accordance with the input information or the performed operation.

An external apparatus 40 which is connected to the terminal apparatuses 10A and 10B through communication in conformity with the Bluetooth® standard is an image forming apparatus forming an image on a sheet of paper in the exemplary embodiment. The external apparatus 40 is not limited to an image forming apparatus, and may be another apparatus as long as this is an apparatus performing communication in conformity with the Bluetooth standard (hereinafter referred to as a Bluetooth device). For example, the external apparatus 40 may be a known Bluetooth device used in such a manner as to be connected to the terminal apparatuses 10A and 10B, such as a scanner, a microphone, a speaker, a projector, a keyboard, or a mouse.

### Configuration of Terminal Apparatus 10A or 10B

FIG. 2 is a diagram illustrating an exemplary hardware configuration of the terminal apparatus 10A or 10B. When corresponding units in the terminal apparatuses 10A and 10B need to be differentiated from each other, for convenience of description, description will be made by adding the alphabet which is present at the end of the reference characters for a terminal apparatus 10, to the end of the reference numeral of the unit. For example, when a unit in the terminal apparatus 10A is to be differentiated from a corresponding one in the terminal apparatus 10B, “A” is added to the end of the reference numeral of the unit of the terminal apparatus 10A.

A touch panel 103 in which a display apparatus such as a liquid-crystal display is combined with a sensor detecting a touch with a finger on the display surface of the display apparatus is an exemplary operation unit operated by a user. The touch panel 103 displays characters, a GUI, a menu screen, and the like. The touch panel 103 detects a position at which a user touches the touch panel 103 with his/her finger, by using the sensor. A controller 101 specifies a user operation in accordance with the position detected by the touch panel 103 and the screen displayed on the touch panel 103, and performs control of units according to the specified operation and various types of processing.

A communication unit 105 functions as a communication interface performing wireless communication with a wireless base station in a mobile communication network (not illustrated). A voice processor 107 has a microphone and a speaker. In the case where the terminal apparatus 10A or 10B is used to make a voice conversation, when the voice processor 107 is supplied with a digital signal according to the voice of the conversation partner from the communication unit 105, the voice processor 107 converts the supplied digital signal into an analog signal. The analog signal is supplied to a speaker, and the speaker outputs the voice of the conversation partner. When the microphone collects voice, the voice processor 107 converts the collected voice into a digital signal. When a voice conversation is made by using the terminal apparatus, the voice processor 107 supplies the digital signal obtained through conversion of voice of a user, to the communication unit 105. The digital signal is transmitted from the communication unit 105 to the mobile communication network, and is transmitted to a terminal apparatus of the conversation partner.

A near-field communication unit 109 functions as a communication interface performing wireless communication in conformity with the Bluetooth standard or wireless communication in conformity with the communication standard of a wireless LAN. The near-field communication unit 109 establishes a connection with an access point of a wireless LAN included in the communication line 2 through communication in conformity with the wireless LAN standard, and performs data communication via the communication line 2. The near-field communication unit 109 which stores Bluetooth device (BD) addresses identifying Bluetooth devices is connected to the external apparatus 40 through communication in conformity with the Bluetooth standard, and performs communication with the external apparatus 40.

A storage unit 102 having a nonvolatile memory which permanently stores data stores programs for the operating system, application programs, and the like. In the present exemplary embodiment, in addition to known application programs installed in a tablet terminal and a smartphone, the storage unit 102 stores application programs (hereinafter referred to as a client application) for establishing a connection with a virtual machine 30 and operating the virtual machine 30, and various types of information used by the client application.

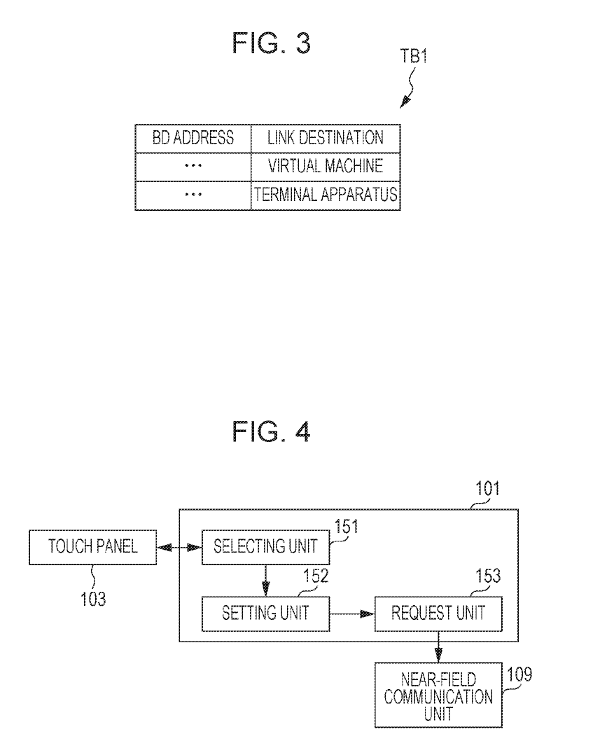

The storage unit 102 stores a connection destination table TB1 in which association of the BD address of the external apparatus 40 with an apparatus that is to use the external apparatus 40 is stored. FIG. 3 is a diagram illustrating an exemplary connection destination table TB1. The connection destination table TB1 has a BD address field and a link destination field. The BD address field stores the BD address of the external apparatus 40 performing Bluetooth communication. The link destination field stores information indicating an apparatus that is to use the external apparatus 40. When a virtual machine 30 is to use the external apparatus 40 connected to the terminal apparatus, information indicating a virtual machine is stored in the link destination field. When the terminal apparatus is to use the external apparatus 40 connected to the terminal apparatus, information indicating the terminal apparatus is stored in the link destination field.

A controller 101 which includes a central processing unit (CPU) and a random access memory (RAM) executes programs for the operating system and application programs. The controller 101 is an exemplary controller according to the exemplary embodiment of the present invention. The controller 101 collaborates with the near-field communication unit 109, and functions as a first connecting section establishing a connection with a virtual machine 30. The controller 101 collaborates with the near-field communication unit 109, and functions as a second connecting section establishing a connection with the external apparatus 40.

### Functional Configuration of Terminal Apparatus 10

FIG. 4 is a functional block diagram illustrating a characteristic functional configuration according to the exemplary embodiment of the present invention, among the functions implemented in a terminal apparatus 10 through execution of the client application.

A selecting unit 151 is an exemplary selecting section which causes a user of the terminal apparatus to select an apparatus that is to use the external apparatus 40. The selecting unit 151 sets a virtual machine 30 or the terminal apparatus as an apparatus that is to use the external apparatus 40.

A setting unit 152 is an exemplary setting section which sets an apparatus that is to use the external apparatus 40, in accordance with the selection result made by the selecting section. When the selecting section selects a virtual machine 30, the setting unit 152 sets a virtual machine 30 as an apparatus that is to use the external apparatus 40. When the selecting section selects the terminal apparatus, the setting unit 152 sets the terminal apparatus as an apparatus that is to use the external apparatus 40.

A request unit 153 is an exemplary request section. After a setting is set by the setting unit 152, when the terminal apparatus connected to a virtual machine 30 detects the external apparatus 40 through searching, the request section requests the virtual machine 30 to use the external apparatus 40, in accordance with the setting set by the setting section.

### Configuration of Server Apparatus 20

FIG. 5 is a block diagram illustrating an exemplary hardware configuration of the server apparatus 20. A communication unit 205 which functions as a communication interface for performing data communication is connected to the communication line 2.

A storage unit 202 has an apparatus (for example, a hard disk apparatus) which permanently stores programs and information used in the programs. Examples of the programs stored in the storage unit 202 include programs for the operating system, a word processor program for creating and editing a document, a spreadsheet program, and programs for implementing a virtual machine 30. Examples of the information stored in the storage unit 202 include a BD address attached to a virtual machine 30, a BD address list L1 which is a list of BD addresses of external apparatuses 40 for which connection with virtual machines 30 has been set, and a pair of the user name and the password of a user who is permitted to use the server apparatus 20 by an administrator. The storage unit 202 stores data used by a user using the server apparatus 20. Example of the data used by a user include a document file used by the word processor program, and a spreadsheet file used by the spreadsheet program.

A controller 201 which includes a CPU and a RAM executes the programs for the operating system, and controls the storage unit 202 and the communication unit 205. When the CPU executes the programs for implementing a virtual machine 30, a virtual machine 30 is invoked for each user who has been authenticated by the server apparatus 20, and the virtual machine 30 is supplied to the terminal apparatus used by the user who has established a connection with the server apparatus 20.

### Functional Configuration of Server Apparatus 20

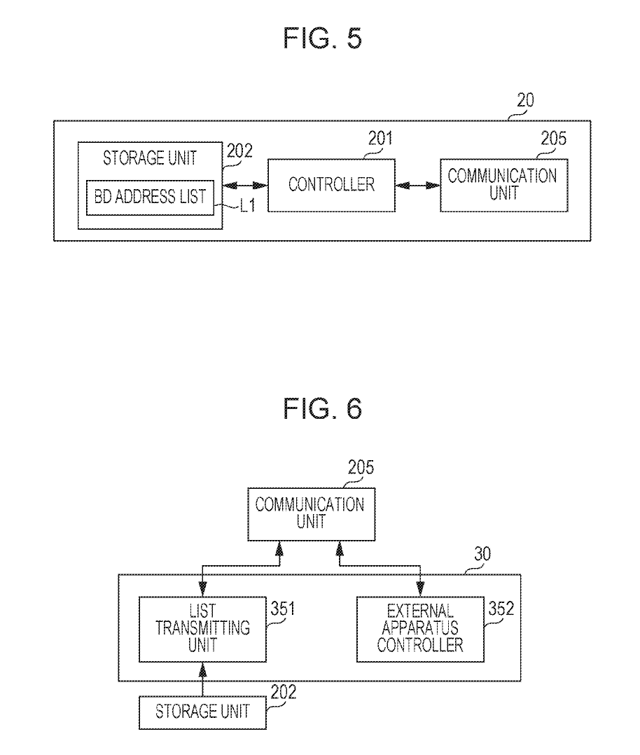

FIG. 6 is a block diagram illustrating the functional configuration according to the exemplary embodiment of the present invention, among the functions implemented in the server apparatus 20.

A list transmitting unit 351 transmits the BD address list L1 stored in the storage unit 202 to the terminal apparatus 10A or 10B in accordance with a request from the terminal apparatus 10A or 10B.

An external apparatus controller 352 prepares the state in which the virtual machine 30 uses the external apparatus 40, in accordance with the request from the terminal apparatus 10A or 10B.

Exemplary Operations according to Exemplary Embodiment

Exemplary operations according to the present exemplary embodiment will be described with reference to drawings. In the description below, exemplary operations will be described under the assumption of the following case. That is, the terminal apparatus 10A is a smartphone (exemplary first terminal apparatus); the terminal apparatus 10B is a tablet terminal (exemplary second terminal apparatus); and the same user operates the terminal apparatuses 10A and 10B.

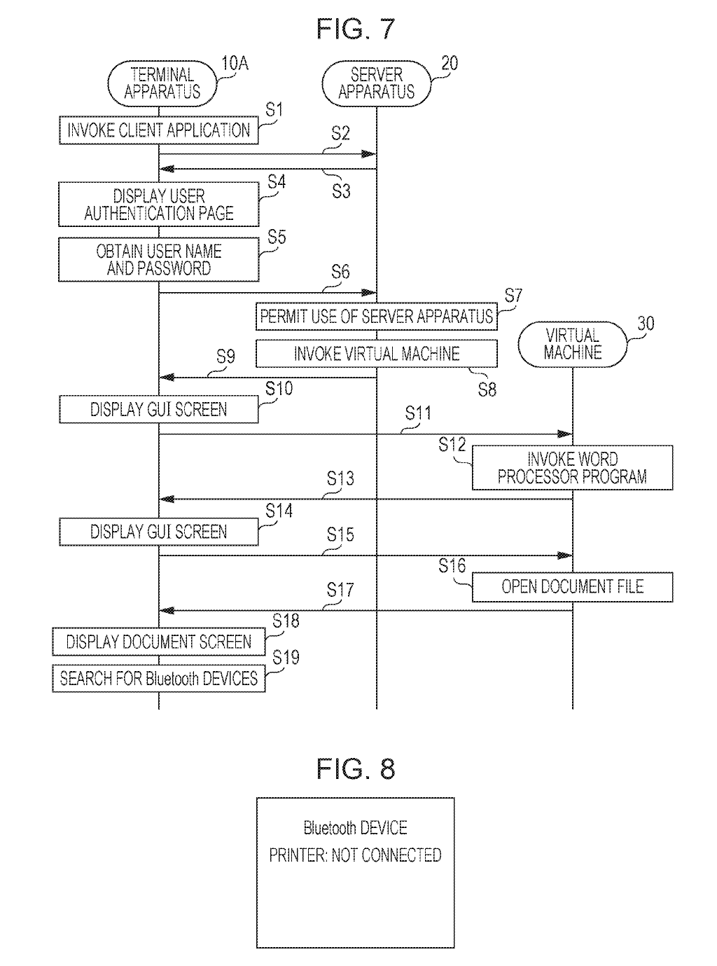

When the user is to operate a virtual machine 30 from the terminal apparatus 10A, the user performs an operation of invoking the client application on the touch panel 103A. The controller 101A invokes the client application in accordance with the operation performed on the touch panel 103A (step S1 in FIG. 7). When the controller 101A invokes the client application, the controller 101A controls the near-field communication unit 109A, and accesses a page for user authentication for using the server apparatus 20 (step S2). The server apparatus 20 transmits the user authentication page to the terminal apparatus 10A in accordance with the access from the terminal apparatus 10A (step S3).

When the near-field communication unit 109A receives the page, the controller 101A controls the touch panel 103A so that the received page is displayed (step S4). When the user inputs a user name and a password of the user on the touch panel 103A on which the user authentication page is displayed, the controller 101A obtains the user name and the password which are input (step S5). When the user performs an operation of transmitting the user name and the password which are input, the controller 101A controls the near-field communication unit 109A so that a pair of the user name and the password which are input is transmitted to the server apparatus 20 (step S6).

If a pair of the user name and the password which have been transmitted has been stored in the storage unit 202, the controller 201 permits the user to use the server apparatus 20 (step S7). When the server apparatus 20 permits the user to use the server apparatus 20, the server apparatus 20 invokes a virtual machine 30 for the user (step S8), and transmits information (hereinafter referred to as screen information) about a GUI screen for operating the virtual machine 30 to the terminal apparatus 10A (step S9).

When the near-field communication unit 109A receives the screen information, the controller 101A controls the touch panel 103A so that a screen representing the received screen information is displayed (step S10). By operating the GUI screen displayed on the touch panel 103A, the user uses the virtual machine 30.

For example, when the user performs an operation of invoking the word processor program on the displayed GUI screen, the controller 101A controls the near-field communication unit 109A so that information indicating the operation performed by the user is transmitted to the virtual machine 30 (step S11). The virtual machine 30 invokes the word processor program in accordance with the information transmitted from the terminal apparatus 10A (step S12), and controls the communication unit 205 so that GUI screen information for the word processor is transmitted to the terminal apparatus 10A (step S13). When the near-field communication unit 109A receives the screen information, the controller 101A controls the touch panel 103A so that a GUI screen representing the received screen information is displayed (step S14).

When the user performs an operation of opening a document file stored in the server apparatus 20, on the displayed GUI screen, the controller 101A controls the near-field communication unit 109A so that information indicating the operation performed by the user is transmitted to the virtual machine 30 (step S15). The virtual machine 30 opens the document file in accordance with information transmitted from the terminal apparatus 10A (step S16), and controls the communication unit 205 so that document screen information representing the opened document file is transmitted to the terminal apparatus 10A (step S17). When the near-field communication unit 109A receives the screen information, the controller 101A controls the touch panel 103A so that a screen representing the received screen information is displayed (step S18).

When the user is to print the displayed document by using the external apparatus 40, the user performs an operation of submitting an instruction to search for Bluetooth devices, on the terminal apparatus 10A. When this operation is performed, the controller 101A controls the near-field communication unit 109A so that Bluetooth devices are searched for (step S19).

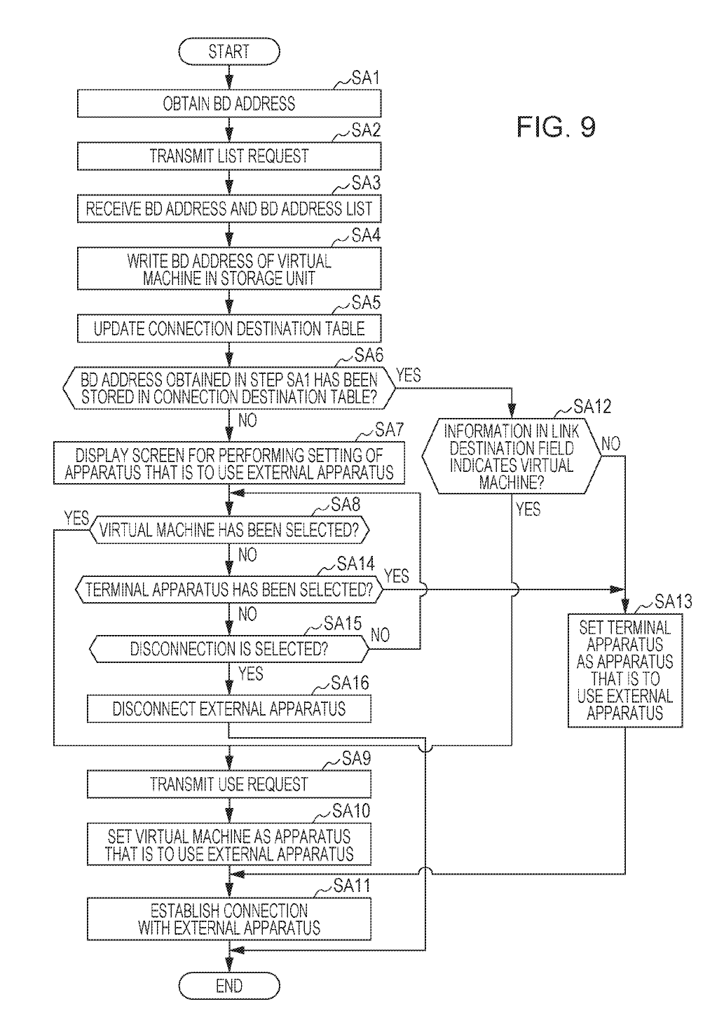

FIG. 8 is a diagram illustrating an exemplary screen displayed by the terminal apparatus 10A when the external apparatus 40 is detected through searching. On this screen, when the user taps on a “printer” portion which indicates the external apparatus 40, the controller 101A performs the process for the flowchart illustrated in FIG. 9.

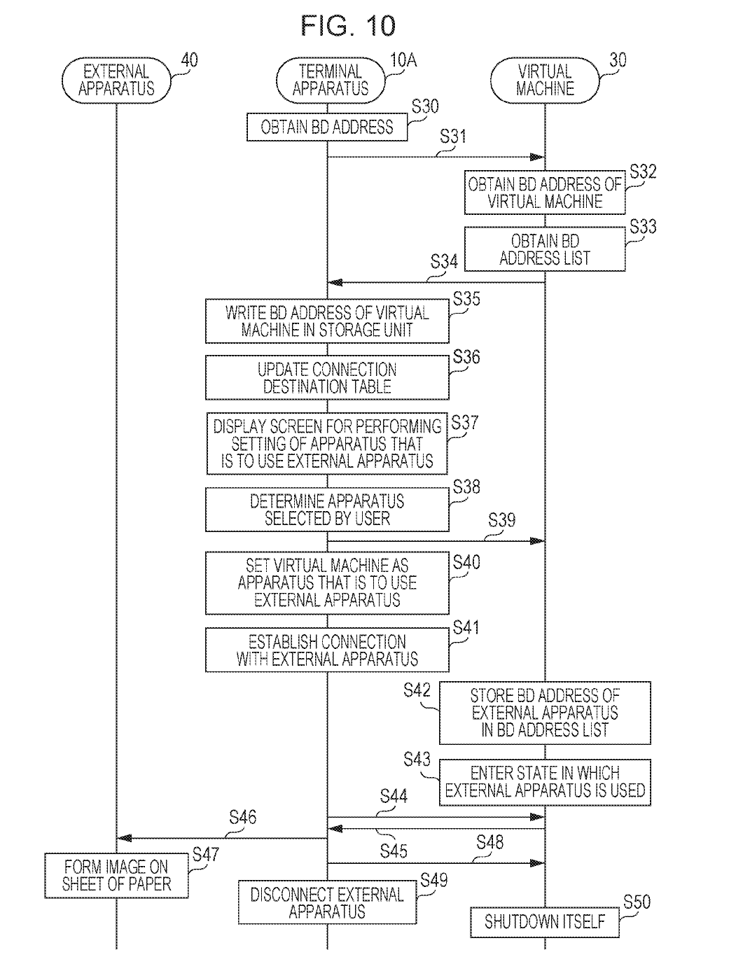

The controller 101A obtains the BD address of the external apparatus 40 (step SA1, step S30 in FIG. 10), and controls the near-field communication unit 109A so that a list request for a BD address list L1 is transmitted to the server apparatus 20 (step SA2, step S31).

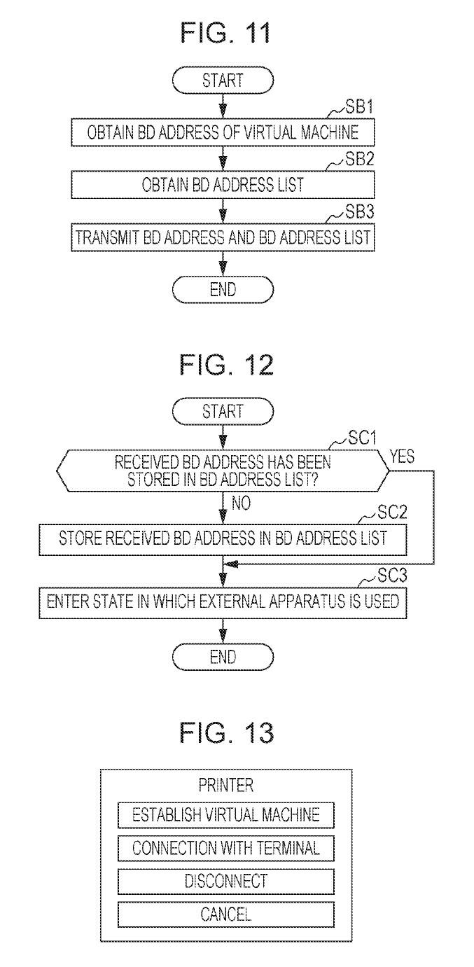

When the communication unit 205 receives the list request, the virtual machine 30 performs the process illustrated in FIG. 11. The virtual machine 30 first obtains the BD address attached to the virtual machine 30 in advance, from the storage unit 202 (step SB1, step S32). The virtual machine 30 then obtains a BD address list L1 corresponding to the user using the virtual machine 30, from the storage unit 202 (step SB2, step S33). The controller 201 controls the communication unit 205 so that the BD address of the virtual machine 30 and the BD address list L1 which are obtained are transmitted to the terminal apparatus 10A (step SB3, step S34).

When the near-field communication unit 109A receives the BD address of the virtual machine 30 and the BD address list L1 (step SA3), the controller 101A writes the received BD address of the virtual machine 30 in the storage unit 102A (step SA4, step S35). The controller 101A updates the connection destination table TB1 (step SA5, step S36). Specifically, the controller 101A newly stores BD addresses which are not stored in the connection destination table TB1, among the BD addresses included in the received BD address list L1, in the connection destination table TB1. When the controller 101A creates a new record to store a BD address in the connection destination table TB1, the controller 101A stores information indicating that the connection destination is a virtual machine, in the link destination field.

The controller 101A determines whether or not the BD address of the external apparatus 40 which is obtained in step SA1 has been stored in the connection destination table TB1 (step SA6). If the BD address obtained in step SA1 has not been stored in the connection destination table TB1, the controller 101A controls the touch panel 103A so that a screen for performing setting of an apparatus that is to use the external apparatus 40 and disconnecting of the external apparatus 40 is displayed (step SA7, step S37).

FIG. 13 is a diagram illustrating an exemplary screen for performing setting of an apparatus that is to use the external apparatus 40 and disconnecting of the external apparatus 40. When an operation of selecting an apparatus that is to use the external apparatus 40 is performed on the touch panel 103A, the controller 101A determines the apparatus selected by the user (step SA8, step S38). When the virtual machine 30 is to use the external apparatus 40, the user taps on a “establish connection with virtual machine” portion. If a tapping operation is performed on the “establish connection with virtual machine” portion (YES in step SA8), the controller 101A transmits a use request which includes the BD address obtained in step SA1 and which is a request for use of the external apparatus 40, to the server apparatus 20 (step SA9, step S39). After transmission of the use request, the controller 101A sets the virtual machine 30 as an apparatus that is to use the external apparatus 40 (step SA10, step S40). The controller 101A establishes a connection with the external apparatus 40 (step SA11, step S41).

When the communication unit 205 receives the use request, the virtual machine 30 determines whether or not the BD address of the external apparatus 40 included in the received use request has been stored in the BD address list L1 (step SC1 in FIG. 12). If the BD address of the external apparatus 40 included in the received use request has not been stored in the BD address list L1 (NO in step SC1), the virtual machine 30 stores the BD address of the external apparatus 40 included in the received use request in the BD address list L1 (step SC2, step S42). Thus, a setting indicating that the virtual machine 30 is to use the external apparatus 40 is set. The controller 201 enters a state in which the external apparatus 40 corresponding to the BD address included in the use request is used (step SC3, step S43).

In the case where the server apparatus 20 enters the state in which the virtual machine 30 uses the external apparatus 40, and where, in the terminal apparatus 10A connected to the external apparatus 40, the virtual machine 30 is set as an apparatus that is to use the external apparatus 40, the external apparatus 40 is available from the virtual machine 30. In the state in which the virtual machine 30 uses the external apparatus 40, when the user performs an operation of printing a document file opened by the virtual machine 30, the controller 101A controls the near-field communication unit 109A so that information indicating the operation performed by the user is transmitted to the virtual machine 30 (step S44). The virtual machine 30 controls the communication unit 205 so that information representing the document opened by the virtual machine 30 and a print request for printing are transmitted to the terminal apparatus 10A, in accordance with the information transmitted from the terminal apparatus 10A (step S45).

When the near-field communication unit 109A receives the print request, the controller 101A controls the near-field communication unit 109A so that the received print request is transmitted to the external apparatus 40 (step S46). When the external apparatus 40 receives the print request transmitted from the terminal apparatus 10A, the external apparatus 40 forms an image of the document represented by the information included in the received print request, on a sheet of paper on the basis of the information, and outputs the sheet of paper (step S47).

When use of the virtual machine 30 is to be ended, the user performs an operation of ending use of the virtual machine 30, on the touch panel 103A. When this operation is performed, the controller 101A controls the near-field communication unit 109A so that an end instruction to end the virtual machine 30 is transmitted to the virtual machine 30 (step S48). The controller 101A controls the near-field communication unit 109A so that the external apparatus 40 is disconnected (step S49). When the communication unit 205 receives the end instruction, the virtual machine 30 shutdowns itself (step S50).

An exemplary operation performed in the case where, after the above-described operation, the user operates the virtual machine 30 by using the terminal apparatus 10B instead of the terminal apparatus 10A will be described.

In the case where the user is to operate the virtual machine 30 from the terminal apparatus 10B instead of the terminal apparatus 10A, the user performs an operation of invoking the client application on the touch panel 103B. Operations performed after the operation of invoking the client application is performed, until the GUI screen for operating the virtual machine 30 is displayed on the terminal apparatus 10B after authentication of the user, are the same as those performed when the user uses the terminal apparatus 10A. Therefore, the description about the operations will not be made.

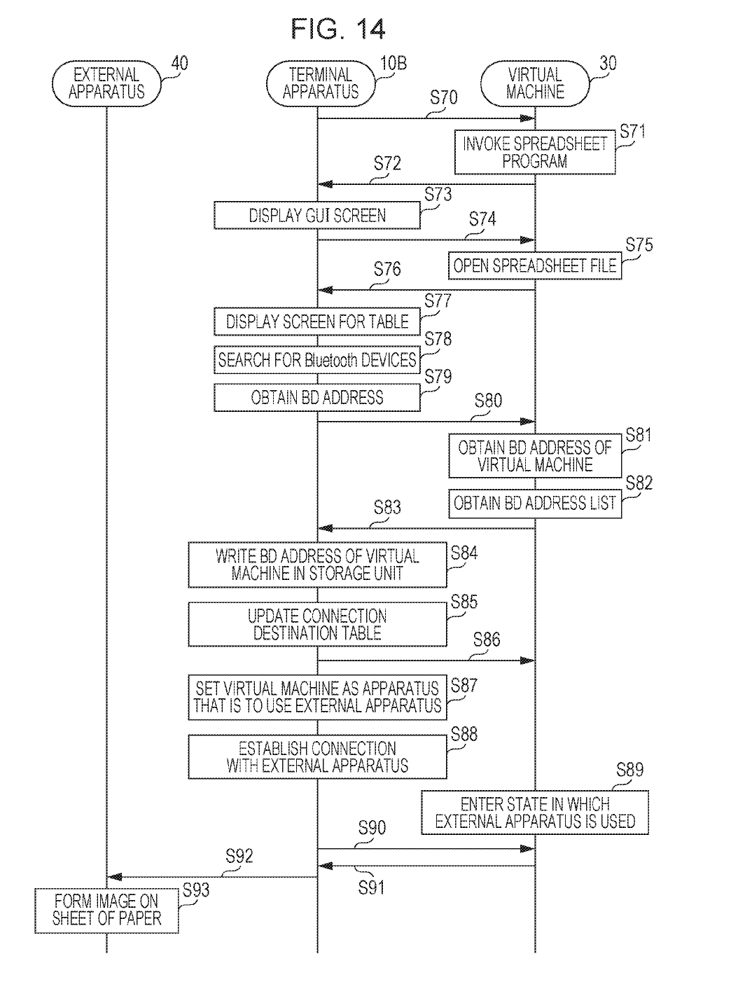

After the GUI screen for operating a virtual machine is displayed on the terminal apparatus 10B, when the user performs an operation of invoking a spreadsheet program on the displayed screen, the controller 101B controls the near-field communication unit 109B so that information indicating the operation performed by the user is transmitted to the virtual machine 30 (step S70 in FIG. 14). The virtual machine 30 invokes the spreadsheet program in accordance with the information transmitted from the terminal apparatus 10B (step S71), and controls the communication unit 205 so that GUI screen information for the spreadsheet is transmitted to the terminal apparatus 10B (step S72). When the near-field communication unit 109B receives the screen information, the controller 101B controls the touch panel 103B so that a GUI screen representing the received screen information is displayed (step S73).

When the user performs an operation of opening a spreadsheet file stored in the server apparatus 20 on the displayed screen, the controller 101B controls the near-field communication unit 109B so that information indicating the operation performed by the user is transmitted to the virtual machine 30 (step S74). The virtual machine 30 opens the spreadsheet file in accordance with the information transmitted from the terminal apparatus 10B (step S75), and controls the communication unit 205 so that table screen information representing the opened spreadsheet file is transmitted to the terminal apparatus 10B (step S76). When the near-field communication unit 109B receives the screen information, the controller 101B controls the touch panel 103B so that a screen representing the received screen information is displayed (step S77).

When the user is to print the displayed document by using the external apparatus 40, the user performs an operation of submitting an instruction to search for Bluetooth devices on the terminal apparatus 10B. When this operation is performed, the controller 101B controls the near-field communication unit 109B so that Bluetooth devices are searched for (step S78).

After the screen in FIG. 8 is displayed on the basis of the search result, when the user taps on the “printer” portion which indicates the external apparatus 40, the controller 101B performs the process for the flowchart illustrated in FIG. 9.

The controller 101B obtains the BD address of the external apparatus 40 (step SA1, step S79), and controls the near-field communication unit 109B so that a list request for a BD address list L1 is transmitted to the server apparatus 20 (step SA2, step S80).

When the communication unit 205 receives the list request, the virtual machine 30 performs the process illustrated in FIG. 11. The virtual machine 30 first obtains the BD address attached to the virtual machine 30 in advance, from the storage unit 202 (step SB1, step S81). The virtual machine 30 then obtains a BD address list L1 corresponding to the user using the virtual machine 30, from the storage unit 202 (step SB2, step S82). The controller 201 controls the communication unit 205 so that the BD address of the virtual machine 30 and the BD address list L1 which are obtained are transmitted to the terminal apparatus 10B (step SB3, step S83). As described above, since the BD address of the external apparatus 40 has been stored in the BD address list L1 through the operation in step S42, the BD address list L1 transmitted in this step includes the BD address of the external apparatus 40.

When the near-field communication unit 109B receives the BD address of the virtual machine 30 and the BD address list L1 (step SA3), the controller 101B writes the received BD address of the virtual machine 30 in the storage unit 102B (step SA4, step S84). The controller 101B updates the connection destination table TB1 (step SA5, step S85). Since the BD address of the external apparatus 40 among the BD addresses included in the received BD address list L1 is not stored in the connection destination table TB1, the controller 101B stores the BD address of the external apparatus 40 in a new record in the connection destination table TB1, and stores information indicating that the connection destination is a virtual machine, in the link destination field. The controller 101B does not update records in which BD addresses are already stored in the connection destination table TB1.

The controller 101B determines whether or not the BD address of the external apparatus 40 which is obtained in step SA1 has been stored in the connection destination table TB1 (step SA6). Since the BD address of the external apparatus 40 has been stored in the connection destination table TB1 in step SA5 which is described above, the controller 101B determines that the obtained BD address of the external apparatus 40 has been stored in the connection destination table TB1 (YES in step SA6).

If the obtained BD address of the external apparatus 40 has been stored in the connection destination table TB1, the controller 101B checks the information in the link destination field for the record in which the BD address of the external apparatus 40 is stored (step SA12). In the connection destination table TB1, as described above, since information indicating that the connection destination is a virtual machine is stored in the link destination field for the record in which the BD address of the external apparatus 40 is stored, the controller 101B determines YES in step SA12. If the controller 101B determines YES in step SA12, the controller 101B transmits a use request including the BD address obtained in step SA1, to the server apparatus 20 (step SA9, step S86). After the controller 101B transmits the use request, the controller 101B sets the virtual machine as an apparatus that is to use the external apparatus 40 (step SA10, step S87). The controller 101B establishes a connection with the external apparatus 40 (step SA11, step S88).

In the server apparatus 20, when the communication unit 205 receives the use request, the virtual machine 30 determines whether or not the BD address of the external apparatus 40 included in the received use request has been stored in the BD address list L1 (step SC1). If the BD address of the external apparatus 40 included in the received use request has been stored in the BD address list L1 (YES in step SC1), the virtual machine 30 enters the state in which the external apparatus 40 corresponding to the BD address included in the use request is used (step SC3, step S89).

In the case where the server apparatus 20 enters the state in which the virtual machine 30 uses the external apparatus 40, and where, in the terminal apparatus 10B connected to the external apparatus 40, the virtual machine 30 is set as an apparatus that is to use the external apparatus 40, the external apparatus 40 is available from the virtual machine 30. In the state in which the virtual machine 30 uses the external apparatus 40, when the user performs an operation of printing a table of the spreadsheet file opened by the virtual machine 30, the controller 101B controls the near-field communication unit 109B so that information indicating the operation performed by the user is transmitted to the virtual machine 30 (step S90). The virtual machine 30 controls the communication unit 205 so that information representing the table of the spreadsheet document opened by the virtual machine 30 and a print request for printing are transmitted to the terminal apparatus 10B, in accordance with the information transmitted from the terminal apparatus 10B (step S91).

When the near-field communication unit 109B receives the print request, the controller 101B controls the near-field communication unit 109B so that the received print request is transmitted to the external apparatus 40 (step S92). When the external apparatus 40 receives the print request transmitted from the terminal apparatus 10B, the external apparatus 40 forms an image of the table represented by the information included in the received print request, on a sheet of paper on the basis of the information, and outputs the sheet of paper (step S93).

In the case where the terminal apparatus 10B is to be set as an apparatus that is to use the external apparatus 40, or where the terminal apparatus 10B is to be disconnected from the external apparatuses 40, the user performs the operation of displaying a screen for a list of the external apparatuses 40 detected through searching for Bluetooth devices, on the touch panel 103B. When this operation is performed, the controller 101B controls the touch panel 103B so that the list (FIG. 8) of the external apparatuses 40 detected in the searching is displayed. When the user is to change the apparatus that is to use the external apparatus 40, the user taps on the “printer” portion. When a tapping operation is performed on the “printer” portion, the controller 101B controls the touch panel 103B so that the screen (FIG. 13) for performing setting of an apparatus that is to use the external apparatus 40 and disconnecting of the external apparatus 40 is displayed.

In this screen, if the user taps on a “disconnect” portion (YES in step SA15), the controller 101B controls the near-field communication unit 109B so that the external apparatus 40 is disconnected (step SA16). When the terminal apparatus 10B is to use the external apparatus 40, the user taps on a “establish connection with terminal” portion. When a tapping operation is performed on the “establish connection with terminal” portion (YES in step SA14), the controller 101B updates the connection destination table TB1 in order to set the terminal apparatus 10B as an apparatus that is to use the external apparatus 40 (step SA13). Specifically, the controller 101B stores information indicating that the connection destination is the terminal apparatus 10B, in the link destination field for the record in which the BD address of the external apparatus 40 is stored in the connection destination table TB1.

The controller 101B transmits an end request which includes the BD address obtained from the external apparatus 40 and which is a request for end of use of the external apparatus 40, to the server apparatus 20. After transmission of the end request, the controller 101B sets the terminal apparatus 10B as an apparatus that is to use the external apparatus 40. The virtual machine 30 ends use of the external apparatus 40 in accordance with the transmitted end request.

### Modified Embodiments

As described above, the embodiment of the present invention is described. However, the present invention is not limited to the above-described embodiment, and various embodiments may be made. For example, the present invention may be implemented by changing the above-described embodiment as described below. The above-described embodiment and modified embodiments described below may be combined with one another.

In the present invention, when the terminal apparatus 10A or 10B is disconnected from the virtual machine 30, the terminal apparatus 10A or 10B may automatically enter a state in which the terminal apparatus 10A or 10B uses the external apparatus 40. In this case, no information indicating that the connection destination is the terminal apparatus 10A or 10B may be stored in the link destination field in the connection destination table TB1. In the cases where the terminal apparatus 10A or 10B itself uses the external apparatus 40, when the terminal apparatus 10A or 10B establishes a connection with a virtual machine 30, the terminal apparatus 10A or 10B may automatically enter a state in which the virtual machine 30 uses the external apparatus 40.

In the present invention, a configuration may be employed in which an operation performed when the external apparatus 40 is detected through searching is set in advance for each external apparatus 40 with which the terminal apparatus 10A (10B) may establish a connection, in the terminal apparatus 10A (10B).

For example, as options for an operation performed when a connection with the virtual machine 30 has been established, three options, “establish connection with virtual machine automatically”, “establish connection with terminal automatically”, and “maintain connection”, are displayed on a menu screen, and the user is prompted to select one of the options. In the case where the user selects “establish connection with virtual machine automatically”, when the terminal apparatus 10A (10B) detects the external apparatus 40, the terminal apparatus 10A (10B) and the virtual machine 30 automatically enter a state in which the virtual machine 30 is capable of using the external apparatus 40. In the case where the user selects “establish connection with terminal automatically”, when the terminal apparatus 10A (10B) detects the external apparatus 40, the terminal apparatus 10A (10B) automatically enters a state in which the terminal apparatus 10A (10B) is capable of using the external apparatus 40. In the case where the user selects “maintain connection”, the connection between the external apparatus 40 and the terminal apparatus 10A (10B) is maintained.

As options for an operation performed when a connection with a virtual machine 30 is not established, two options, “establish connection with terminal automatically” and “maintain connection”, are displayed on a menu screen, and the user is prompted to select one of the options. In the case where the user selects “establish connection with terminal automatically”, when the terminal apparatus 10A (10B) detects the external apparatus 40, the terminal apparatus 10A (10B) automatically enters the state in which the terminal apparatus 10A (10B) is capable of using the external apparatus 40. In the case where the user selects “maintain connection”, the connection between the external apparatus 40 and the terminal apparatus 10A (10B) is maintained.

In the present invention, the external apparatus 40 paired with a virtual machine 30 may be a microphone. In the case where the apparatus paired with the virtual machine 30 is a microphone, when the terminal apparatus 10A receives a call, the terminal apparatus 10A may be set as an apparatus paired with the external apparatus 40 only from start to end of the call.

In the present invention, when the terminal apparatus 10A (10B) establishes a connection with a virtual machine 30 via a mobile communication network, the external apparatus 40 does not need to be paired with the virtual machine 30.

The configuration in which the external apparatus 40 is connected to the terminal apparatuses 10A and 10B through communication in conformity with the Bluetooth standard is not limiting. For example, a configuration may be employed in which the external apparatus 40 is connected to the terminal apparatuses 10A and 10B through connection in conformity with a wireless LAN standard. The configuration in which the external apparatus 40 is connected to the terminal apparatuses 10A and 10B through wireless communication is not limiting. A configuration in which the external apparatus 40 is connected to the terminal apparatuses 10A and 10B through a wired cable may be employed.

A program in each apparatus according to the present invention may be provided by using a computer-readable recording medium, such as a magnetic recording medium (a magnetic tape, a magnetic disk (for example, a hard disk drive (HDD) or a flexible disk (FD)), and the like), an optical recording medium (for example, an optical disk), a magneto-optical recording medium, or a semiconductor memory, which stores the program, and may be installed. Alternatively, the program may be downloaded through a communication line, and may be installed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a virtual machine;
a first terminal apparatus; and
a second terminal apparatus different from the first terminal apparatus,
wherein, in the case where the virtual machine is connected to the first terminal apparatus, when the first terminal apparatus detects an external apparatus, the virtual machine sets a setting indicating that the virtual machine is to use the external apparatus, and
wherein, in the case where the virtual machine is connected to the second terminal apparatus, when the second terminal apparatus detects the external apparatus, the virtual machine uses the external apparatus by using the setting.

2. An information processing system comprising:
a virtual machine;
a selecting section that, when a first terminal apparatus connected to the virtual machine detects an external apparatus, causes a user of the first terminal apparatus to select an apparatus that is to use the external apparatus; and
a setting section that, when the virtual machine is selected by using the selecting section, sets the virtual machine as the apparatus that is to use the external apparatus,
wherein, when the first terminal apparatus connected to the virtual machine or the second terminal apparatus connected to the virtual machine detects the external apparatus after the setting is set, the virtual machine uses the external apparatus on a basis of the setting.

3. The information processing system according to claim 2,
wherein, when the first terminal apparatus connected to the virtual machine or the second terminal apparatus connected to the virtual machine is disconnected from the virtual machine, the first terminal apparatus disconnected from the virtual machine or the second terminal apparatus disconnected from the virtual machine uses the external apparatus.

4. A terminal apparatus comprising:
a first connecting section that establishes a connection with a virtual machine;
a second connecting section that establishes a connection with an external apparatus; and
a controller that, in the case where the first connecting section establishes a connection with the virtual machine, when a setting indicating that the virtual machine is to use the external apparatus is obtained from the virtual machine, causes the virtual machine to use the external apparatus connected to the terminal apparatus by using the second connecting section, without performing again an operation in which the virtual machine sets a setting indicating that the virtual machine is to use the external apparatus.

5. A non-transitory computer readable medium storing a program causing a computer to execute a process for a terminal apparatus, the process comprising:
establishing a connection with a virtual machine;
establishing a connection with an external apparatus; and
in the case where the connection with the virtual machine is established, when a setting indicating that the virtual machine is to use the external apparatus is obtained from the virtual machine, causing the virtual machine to use the external apparatus connected to the terminal apparatus, without performing again an operation in which the virtual machine sets a setting indicating that the virtual machine is to use the external apparatus.
